(19) United States
(12) Patent Application Publication
(10) Pub. No.: US 2008/0214062 A1
(43) Pub. Date: Sep. 4, 2008

(54) Telecommunications Module and a Method of Manufacturing the Same

(76) Inventor: Friedrich W. Denter, Castrop-Rauxel (DE)

Correspondence Address: 3M INNOVATIVE PROPERTIES COMPANY, PO BOX 33427, ST. PAUL, MN, 55133-3427, US

(21) Appl. No.: 11/908,523

(22) PCT Filed: Mar. 20, 2006
(86) PCT No.: PCT/US06/10253

§ 371 Date: Sep. 13, 2007

(30) Foreign Application Priority Data
Mar. 21, 2005 (EP) 05006094.6

(51) Int. Cl. H01R 13/24; H01R 43/20

(52) U.S. Cl. 439/775; 29/876

(57) ABSTRACT

A telecommunications module (10) has at least one contact element (12) and a housing (14), into which the contact element (12) is inserted, wherein the housing (14) comprises at least one first guide (16) with which at least a portion of the contact element (12) comes in contact during insertion thereof, so as to deflect at least a portion of the contact element (12).

### TECHNICAL FIELD

The invention relates to a telecommunications module, a distribution point in the field of telecommunications, a method of manufacturing a telecommunications module and a use of a guide formed on a housing of a telecommunications module.

### BACKGROUND

In the field of telecommunications, numerous customers are connected with the switch of a telecommunications company via telecommunications lines. The customers can also be called subscribers. The switch is also called an exchange or PBX (central office exchange operated by the telecommunications company). Between the subscriber and the switch, sections of the telecommunications lines are connected with telecommunications modules. The telecommunications modules establish an electrical connection between a wire, which is attached to the telecommunications module at a first side, and another wire, which is attached to the telecommunications module at a second side. The wires of one side can also be called incoming wires and the wires of the other side can be called outgoing wires. Plural telecommunications modules can be put together at a distribution point, such as a main distribution frame, an intermediate distribution frame, an outside cabinet or a distribution point located, for example, in an office building or on a particular floor of an office building. To allow flexible wiring, some telecommunications lines are connected with first telecommunications modules in a manner to constitute a permanent connection. Flexibility is realized by so-called jumpers or cross connects, which flexibly connect contacts of the first telecommunications module with contacts of a second telecommunications module. These jumpers can be changed when a person moves within an office building to provide a different telephone (i.e. a different telephone line) with a certain telephone number, which the relocated person intends to keep. In the telecommunications module, disconnection points can be located in the electrical connection between the two sides. At such disconnection points, disconnection plugs can be inserted, in order to disconnect the line. Furthermore, protection plugs and magazines are known. These are connected to the module and protect any equipment connected to the wires from overcurrent and overvoltage. Finally, test plugs can be inserted at a disconnection point in order to test or monitor a line.

Recently, ADSL-technology has spread widely in the field of telecommunications. This technology allows at least two different signals to be transmitted on a single line. This is achieved by transmitting the different signals at different frequencies along the same line. The signals are combined at a particular point in the telecommunications line and split at another point. In particular, at the subscriber side, voice and data signals, which are separate, are combined and sent to the central office via the same line. In the central office the combined signal is split. The voice signal is then directed to the other subscriber(s) on the telephone call, and the data signal is directed to the other subscriber(s) participating in the data exchange. For the transmission of voice and data signals to the subscriber, separate voice and data signals are combined at the central office, sent to the subscriber and split at the subscriber side. After splitting the signal, the so-called POTS-signal (plain old telephone service) can be used to transmit voice signals. The remaining part of the split signal can be used to transmit data, for example. So-called splitters, which are used to split or combine the signal, can generally be arranged at any distribution point.

Any electronic components, which are necessary to perform the above functions, can be contained, possibly together with a printed circuit board as a base, in a functional module, which can be called a splitter module. Similar functional modules are protection modules, which contain any components which provide protection against overvoltage and/or overcurrent, as well as testing and monitoring modules, which contain suitable electronic components and circuits in order to test and/or monitor a telecommunications line. Furthermore, other functional modules in the above sense are known to those skilled in the art.

EP 05004795.0 of the Applicant, entitled “A telecommunications module, an assembly of a telecommunications module and at least one outside module and a method of using a telecommunications module”, filed Mar. 4, 2005, is related to a telecommunications module having a housing and at least one contact comprising a contact element.

### SUMMARY OF THE INVENTION

The invention provides a telecommunications module which is improved with regard to the manufacture thereof, a distribution point comprising at least one telecommunications module, and an improved method for manufacturing a telecommunications module as well as a novel use of a guide formed on a housing of a telecommunications module. In particular, the invention solves the problem of reliably inserting one or more contact elements into a telecommunications module to a desired position and/or with a desired shape, also when the required path of movement or the necessary deflection is relatively complicated and possibly interferes with structures, which are present in the telecommunications module.

The telecommunications module, firstly, comprises a housing. The housing can be made of plastic or any other suitable material and can be constituted by one or more components. The housing serves to accommodate the contact elements of the telecommunications module, as detailed below. The housing can also have specific structures for positioning the contact elements therein. Moreover, the housing can comprise one or more cavities or receiving spaces, which are adapted to accommodate the contact elements and/or objects such as the functional modules described above or any other types of outside modules or parts thereof. Finally, the housing can comprise suitable structures, typically at the outside thereof, to enable the telecommunications module to be mounted to a rack or any other suitable carrier in the field of telecommunications.

The telecommunications module, secondly, comprises at least one contact element. A contact element generally means any component, which is, firstly, adapted to establish electrical connection with at least one wire. For this purpose, the contact element can, for example, at a first end thereof, be formed as an IDC (Insulation Displacement Contact), a wire wrap contact or in any other suitable manner. A contact can consist of a single contact element, on the first end of which a wire is connected, and on a second end of which an electrical connection with a further component is established. This can, for example, be the outside contact of an outside module, such as splitter module. In this case, the signal, which is transmitted from the wire to the contact element, is further transmitted to the electronic components of the splitter modules and is processed by these. The contact can also comprise a second contact element, on the first end of which a wire can be connected. The second end of the second contact element can, for example, be connected with a splitter module, so that the signal, which is processed, split or combined by the splitter module is, via the second contact element, transmitted to the wire connected with the first end of the second contact element. It is, however, to be emphasized that a particular contact of the telecommunications module described herein does not necessarily comprise two contact elements, but one contact element called the first contact element, can be sufficient. Furthermore, the contact element can at least be partially located outside the housing. In particular, the housing and/or the contact and the contact elements of the telecommunications module described herein can be formed as described in EP 05004795.0 of the Applicant entitled “A telecommunications module, an assembly of a telecommunications module and at least one outside module and a method of using a telecommunications module”, filed Mar. 4, 2005. The disclosure thereof is incorporated herein by reference.

In the telecommunications module described herein, the contact element is inserted into the housing. This insertion can, for example, be effected during manufacture of the telecommunications module. However, the telecommunications module can also be of a type, in which one or more contact elements are removable also at a point in time after the manufacture thereof, even after it has been used for a certain period of time, and the contact elements can be reinsertable into the housing. In this context, the one or more contact elements of a first type could be exchangeable for one or more contact elements of a second type. Moreover, the contact elements can be inserted into the housing, in a state, in which it is complete in the sense that it can be employed in a distribution point so as to perform one or more of the above functions. However, the contact elements can also be inserted into a part of a housing which is, after insertion of the contact elements, combined with a second part of the housing so as to constitute a “complete housing” which allows the telecommunications module to be employed in a distribution point.

In the telecommunications module described herein, the housing comprises at least one first guide with which at least a portion of the contact element comes in contact, at least during a part of the insertion thereof, so as to deflect at least a portion of the contact element. The guide can be any suitable shape or structure on the housing or a part thereof which is adapted to interact with a portion of the contact element to the effect that the contact element is deflected. Since the contact element can be inserted into the interior of the housing, the guide can be provided in the interior and/or any suitable cavity of the housing. The guide can be formed as one or more projections which generally project in a direction perpendicular to the insertion direction. The guide, moreover, can have a certain extension in the insertion direction. This serves to guide, move or deflect the contact element during its movement in the insertion direction, in the desired manner. In particular, such a projection can be formed as a step, which implies that at least the portions immediately adjacent the step on different sides thereof are at a somewhat different level, so that the step presents a surface on which the contact element can be guided. The same effects can be obtained by a series of projections, for example pins or points. The guide in any of the embodiments described herein can be integrally molded with the housing of the telecommunications module, or it can be formed as a separate component. Moreover, the guide can be formed as a groove, in which the contact element or a portion thereof is guided. For example, the contact element can have one or more projections, which protrude into the groove for guiding the contact element during insertion thereof. Moreover, such projection(s) can also interact with the above-described step. Finally, herein below, embodiments with more than one guide will be described. It is to be noted that the one or more guides can be of the same or any different structure, as desired.

The provision of the guide facilitates the manufacture of the telecommunications module, in particular, the insertion of the contact elements, as the guide can bring the contact element into the desired position and/or shape and/or orientation without the need of any tool or manipulator handling the contact element during the insertion thereof from the outside of the module. In particular, it is highly complicated and can be impossible, or at least very complicated and thus not desired with regard to cost-efficiency, to act on the contact element in the described manner from outside the module. However, the guide of the telecommunications module described herein can perform this function from the inside of the module. In particular, the guide can be an integrated with or constitute an integral part of the housing, which can be made of plastic, so that the described effect can be obtained easily by providing a suitable structure in the mould, in which the housing is formed. With the guide, it can particularly be ensured that the contact element can be inserted to the desired position and/or with a desired shape and/or orientation without colliding with any portions of the housing and/or other contact elements. Thus, the aspect of deflecting the contact element can mean to change its shape and/or orientation as well as to generally move the contact element in a desired way.

Moreover, the guide cannot only serve to prevent collisions of the contact element with portions of the telecommunications module's housing or other contact elements. Rather, the guide can instead thereof or in addition thereto serve to guide and/or keep the contact element to/at a position and/or to/in a shape, in which it is for example permanently disconnected from an adjacent contact element. Hereinafter, a telecommunications module with a disconnection portion provided in the housing will be described. However, the same effects as discussed below for the disconnection portion can be realized by a suitably formed guide.

Generally, the contact element as a whole can be deflected without changing its shape. However, the invention provides specific advantages, when the contact element is resilient and is resiliently deflected, for example, deflected into a bent position and/or shape. The contact element being resilient implies that it is flexible and/or elastic so that it can be deflected to a certain extent and tends to return to its original shape due to the elastic forces. When the contact element is resilient it can be particularly difficult to move the contact element in a manner to avoid collisions with portions of the housing and/or other contact elements, at which it can be desired that the contact element abuts these with a certain biasing force. However, with the guide described herein, the contact element can reliably be brought into the desired shape and/or position.

The housing can comprise at least one second guide, with which at least a portion of the contact element is in contact, at least during a part of the insertion thereof, so as to apply a force in an opposing direction when the contact element is deflected. As mentioned above, the first guide can generally serve to define a certain path of movement for the contact element during insertion thereof. However, particularly when the contact element is resilient, there can be the need of applying a force in an opposing direction so as to bring the contact element into the desired shape and/or position. The described second guide advantageously serves to apply such a force in an opposing direction. In a similar manner as the first guide, the second guide can be formed along the entire path of movement of the contact element during the insertion thereof, or only along one or more parts of this path. As an alternative, the housing does not necessarily need to have a second guide applying a force in an opposing direction. Rather, the force in an opposing direction can, for example, be applied by the hand of an individual inserting the contact element. Furthermore, a suitable manipulator or handling device can insert the contact element and can grip the contact element, at least at a portion thereof, in a manner to apply the force in an opposing direction, which might be required if a portion of the contact element is resiliently deflected or deflected. Alternatively, the force in an opposing direction can also be applied by an operator's hand or finger, when the contact element is inserted.

The contact element can, for example, be a generally strip-like element with a certain length extending substantially in the insertion direction, a width extending perpendicular to the insertion direction, and a thickness, which also extends perpendicular to the insertion direction and generally corresponds to a thickness of the sheet metal, from which the contact element can be stamped. The contact element can have an insulation displacement contact or connector (IDC) slit which substantially extends in the insertion direction. Furthermore, the contact element can be bent at one or more locations along the length thereof. With a contact element having a width extending perpendicular to the insertion direction, the first guide can have a dimension in the width direction of the contact element, which is less than the width of the contact element. Thus, the guide can be formed as a small step extending in the width direction, on which step the contact element is guided. Furthermore, in order to effect the desired deflection of the contact element, the guide, particularly the step, can have a certain dimension in the insertion direction. However, the guide can also be formed as any kind of projection, which is present at least partially along the insertion direction of the contact element, so as to deflect the contact element during the insertion thereof, to a desired degree, in the desired manner. Moreover, the guide can be formed as a groove, and the contact element can have a projection extending in the width direction thereof, which projection is guided in the groove.

In its interior, the housing can comprise a contact receiving space, in which at least one first guide is provided for each contact element. The contact receiving space is generally adapted to receive or accommodate one or more contact elements. In particular, more than one contact element (typically a first and a second contact element) can be accommodated in a specific contact receiving space, and an incoming wire and an outgoing wire of a particular telecommunications line can be connected with the first and second contact element, respectively. With the provision of at least two first guides in a receiving space, any interference between the at least two contact elements during the insertion thereof can be avoided.

In order to allow a smooth interaction between the guide and the contact element, it has been found advantageous to form the guide so as to comprise a convex portion.

In particular, the convex portion can be formed as a ramp, preferably with smooth and/or rounded ends, so as to smoothly and reliably guide the contact element during insertion thereof.

Generally, the portion of the contact element interacting with the guide can be formed in any suitable manner, with a convex portion that contacts the guide during the insertion of the contact element being currently preferred.

In particular, experiments have shown that a convex portion, which is rounded, is particularly advantageous.

As mentioned above, the invention provides advantages in any situation, in which a contact element is to be brought to a particular position and/or orientation and/or shape. However, this is particularly difficult when the contact element is, in the fully inserted state, at least partially resiliently deflected. With this deflection, the contact element can be in a shape, which is different from its original shape. However, due to its resiliency, it will tend to return to its original shape. The above-mentioned difficulty arises because the resiliency of the contact element tends to urge the contact element into a shape and/or position during the insertion thereof, which is generally to be avoided because it might lead to collisions between the contact element and any structures or portions of the telecommunications module or further contact elements. However, in the fully inserted state, it might be desirable to have the contact element in a resiliently deflected shape, so that the contact element can, for example, abut a second contact element with a certain biasing force. Such a biasing force can, for example, provide a reliable electrical contact and at such a point, where two separate contact elements are in contact with each other. This point can be called a disconnection point, as it is a disconnectable contact point. In such a situation the invention leads to significant advantages because the desired position and/or orientation and/or shape of the contact element in the fully inserted state can reliably be obtained by the novel guide without any collisions during the insertion thereof.

As an example, the housing of the novel telecommunications module can comprise at least one disconnection portion, at which at least two contact elements abut so as to be permanently disconnected. The contact elements can abut this disconnection portion with a certain biasing force, so that they have the tendency to interfere with this portion, at which they are to abut, during the insertion. The guide advantageously serves to avoid any undesired interference between the contact element and the disconnection portion. The disconnection portion can keep two contact elements disconnected which are used for entirely different purposes so that they have to be kept disconnected. For example, in a splitter module, a first contact element could be used as a grounding contact and the opposite contact, which would be in touch with the above-mentioned first contact element, if the disconnection portion was not there, could provide a connection to a DSLAM. In this context, the disconnection portion can also be present at every other pair of opposing contact elements in a row of contact elements. Thus, in this example, every other pair of opposing contact elements will be connected, whereas the pairs of contact elements inbetween will be permanently disconnected. Moreover, a module, in which two opposing contact elements are permanently disconnected, could be used as a switching module. In a switching module two opposing contact elements are permanently disconnected and can, for example, be connected by a protection module, which is fitted to the switching module. Thus, it is ensured that a connection between opposing contact elements is only made, when protection is present.

The disconnection portion can be formed integral with the housing or a part thereof. Apart from an embodiment, in which the disconnection portion is formed in one piece with the housing, it can also be integrated with the housing or a part thereof. This implies that the disconnection portion is originally a component separate from the housing and is inserted into the housing during the manufacture of the telecommunications module, preferably before the insertion of the contact element.

In particular, the contact element can be formed so that the convex portion, which cooperates with the guide during the insertion of the contact element, abuts the disconnection portion in the fully inserted state of the contact element.

The invention also provides a distribution point in the field of telecommunications, such as a main distribution frame, comprising at least one telecommunications module in one or more of the embodiments described above. Thus, the advantages of the novel telecommunications module can be realized for the distribution point as a whole.

In the novel method of manufacturing a telecommunications module, which comprises at the step of inserting at least one contact element into a housing having at least one first guide, the contact element is at least partially deflected by the guide. As detailed above, this method advantageously serves to facilitate the manufacture of telecommunications modules because the contact element can be brought into the desired position and/or orientation and/or shape without the need of complicated manipulators or similar devices acting from outside the module. Rather, the described guide acts upon the contact element from the inside of the module. This provides a repeatable and reliable insertion movement and avoids the need for complicated manipulators or similar devices acting from the outside of the module.

In this context, preferred embodiments of the method correspond to preferred embodiments of the telecommunications module to be produced by the method as described above.

Finally, the invention also provides a use of a first guide formed on a housing of a telecommunications module for at least partially deflecting at least one contact element during insertion thereof into the housing. Thus, the invention presents an advantageous use of a guide formed on a housing, as the guide reliably deflects the contact element to the desired position and/or orientation and/or shape, so that the manufacture of the telecommunications module is remarkably facilitated.

Also in connection with the use described herein, preferred embodiments thereof correspond to preferred embodiments of the telecommunications module.

### BRIEF DESCRIPTION OF THE DRAWINGS

Hereinafter, the invention will be described by non-limiting examples thereof with reference to the drawings, in which:

FIG. 1 shows a part of a housing and a contact element of the telecommunications module in a first stage of inserting the contact element into the housing.

FIG. 2 shows a part of a housing and a contact element of the telecommunications module in a second stage of inserting the contact element into the housing.

FIG. 3 shows a part of a housing and a contact element of the telecommunications module in a third stage of inserting the contact element into the housing.

FIG. 4 shows a part of a housing and a contact element of the telecommunications module in a fourth stage of inserting the contact element into the housing.

### DESCRIPTION OF A PREFERRED EMBODIMENT OF THE INVENTION

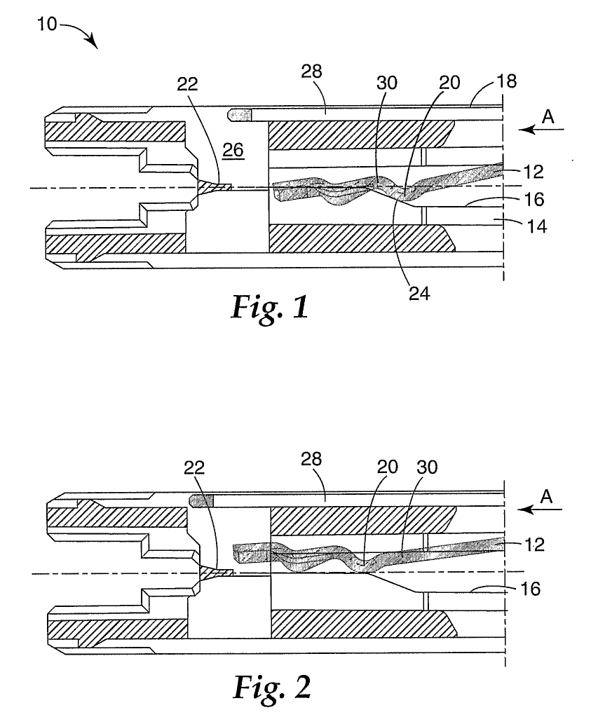

FIG. 1 shows the interior of the telecommunications module 10 during a first stage of inserting a contact element 12 into the housing 14. As will be apparent to those skilled in the art, the telecommunications module 10 can be formed as a strip-type module with its largest dimension extending perpendicular to the plane of the drawing of FIG. 1. Thus, there are plural contact elements 12, such as the one shown in FIG. 1, arranged in one or more rows extending perpendicular to the plane of the drawing of FIG. 1. In the illustrated embodiment two rows of contact elements will be present. However, in all figures the contact element of a second, lower row is omitted for the sake of clarity. However, it should be mentioned that the contact elements of the second row are, in the illustrated embodiment, mirror images of the contact element 12 shown in FIG. 1 with the mirror axis extending horizontally.

In view of the above-described rows of contacts extending perpendicular to the plane of the drawing, further contact elements are, in the illustrated embodiment, present “in front” and “behind” the plane of the drawing of FIG. 1. Moreover, in order to reliably position and retain the contact elements, they are, in the embodiment shown, covered by parts of the housing in all directions, including the direction perpendicular to the plane of the drawing of FIG. 1. However, in order to show the structure and effects of the present invention, a part of the housing has been removed, so that an interior part of the housing, and particular a contact receiving space 26 thereof is shown.

As regards the contact element 12, it is to be noted that two legs, a fixed leg 28 and a resilient leg 30 are shown for the illustrated embodiment. However, these legs 28, will, in the area further right of the section show in FIG. 1, be connected with each other. In particular, the legs 28, 30 can constitute the second and third contact portion of a contact of the telecommunications module described in EP 05004812.3 entitled “A telecommunications module, an assembly of a telecommunications module and at least one outside module, a method for manufacturing a telecommunications module, and a use of a telecommunications module”, by the Applicant, filed Mar. 4, 2005. In particular, any detail thereof regarding the contacts and the housing of the telecommunications module are incorporated herein by reference. This also applies for the earlier filed application of the Applicant mentioned in the introductory part of the specification. However, the leg 30 described herein is different from the corresponding leg in the contact described in the above-mentioned application, due to the convex portion 20 described in more detail below. It will be apparent that the legs 28, 30 are connected with each other and can have a further, called first contact portion, at a location further right of the section shown in the figures. However, in connection with the novel telecommunications module described herein, the parts shown in the drawing are sufficient to explain the invention and the effects obtained thereby.

As regards the contact element 12 and the legs 28, 30 thereof, it should be mentioned that these are, in the illustrated embodiment, stamped from sheet metal, with a thickness of the sheet metal and, therefore, of the legs 28, extending vertically in FIG. 1. The contact element 12 and the legs 28, 30 thereof, furthermore, have a generally strip-like appearance with a length extending substantially in the insertion direction A and a width extending perpendicular to the plane of the drawing of FIG. 1. In the embodiment shown, the fixed leg 28 is substantially straight and the resilient leg 30 comprises various bends as detailed in the above-referenced applications. In the context of the novel telecommunications module described herein, the portion denoted 20 is important. In the illustrated embodiment, this is a convex portion, which interacts with the first guide 16 as described in more detail below. The convexity of convex portion 20 is formed in a direction away from the other, fixed leg 28 of the contact element.

The convex portion 20 interacts with the guide 16 as follows. The guide 16 is, in the illustrated embodiment, formed as a small step, when viewed in a top-down direction in FIG. 1. The step extends, firstly, in the width direction of the contact element 12, i.e. perpendicular to the plane of the drawing of FIG. 1. The formation of a step implies that at least the portion immediately above the guide 16, shown in the drawing, is “further away” from the viewer of the figures, than the portion immediately below the guide 16. Furthermore, in the illustrated embodiment, the guide 16 extends throughout the section shown in FIG. 1 to a disconnection portion 22 discussed below. However, this does not necessarily have to be the case, rather the guide 16 can be formed only partially along the insertion direction. The guide 16 deflects the resilient leg 30 of the contact element 12 so as to avoid an undesired collision with the disconnection portion 22 of the housing. As can be taken from FIG. 1, if the contact element 12 is further inserted in direction A, with the general shape and orientation of the contact element 12 remaining that shown in FIG. 1, the tip of the resilient leg 30 would collide with the disconnection portion 22.

However, the guide 16, which is, in the illustrated embodiment, formed as a type of ramp, avoids such a collision. For this purpose, the guide 16 is formed, beginning from a lower level at the very right end of FIG. 1, as a ramp leading to a higher level. Thus, the ramp is present in a direction from right to left, in the illustrated embodiment. Due to the ramp, as soon as the convex portion 20 of the contact element 12 comes into contact with the guide, as shown in FIG. 1, the resilient leg 30 is deflected in an upwards direction. As can be taken from a comparison of FIGS. 1 and 2, in the illustrated embodiment, the so-called resilient leg 30 is, in the portion shown in the drawings, relatively rigid, so that it has not changed its shape as such. However, the connection with the remainder of the contact element 12 is resilient, so that the resilient leg 30 was brought into the deflected orientation shown in FIG. 2.

FIG. 2 shows the effect of this deflection. In particular, as a consequence of further movement of the contact element in the insertion direction A, convex portion 20 of the contact element 12 has moved along and up the ramp formed by the guide 16, so that tip of the resilient leg 30 of the contact element 12 has not collided with the disconnection portion 22, although it has already reached the same point in the insertion direction A, where the disconnection portion 22 is formed. However, the resilient leg 30 has been deflected in a upward direction so as to avoid this undesired collision. As can be taken from the top of FIG. 2, the so-called fixed leg 28 has not changed its position in an upward/downward direction. This is because a suitable force in an opposing direction has been applied by a second guide in which the fixed leg 28 is guided in the illustrated embodiment, in a manner which is not visible in the drawings. Therefore, the force, which the ramp applies to the resilient leg 30 in an upward direction, is appropriately counteracted.

As can be taken from FIG. 2, the guide 16 would not necessarily have to be formed in the area to the left of the point, where the convex portion 20 of the contact element 12 touches the guide 16 in the situation shown in FIG. 2. This is because the collision of the tip of the resilient leg 30 has already been avoided, and the remaining part of the resilient leg 30 could slide along the disconnection portion 22 without the guide 16 keeping the resilient leg 30 at a distance from the disconnection portion 22. However, in the embodiment shown, the guide 16 extends all the way to the disconnection portion 22 for illustrative purposes.

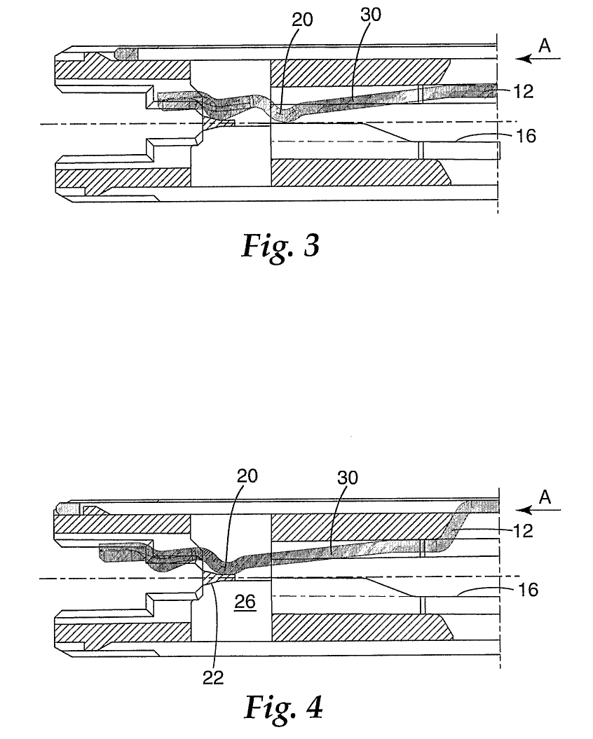

FIG. 3 shows a third stage of inserting the contact element 12 in insertion direction A, which does not differ substantially from the situation shown in FIG. 2. However, the contact element 12 has been inserted further in insertion direction A.

FIG. 4 shows the fully inserted state, from which it can be taken that the convex portion 20 abuts the disconnection portion 22 in the embodiment shown. It should be noted that the disconnection portion 22 can provide specific advantages, for example, when the contact element 12 shown, is a ground contact, which is to be kept disconnected from its “mirror image” contact (not shown) at which a wire, for example, leading to a DSLAM can be connected. The “mirror image” contact, which is not shown in the drawings, would be present in the figures below disconnection portion 22 with the mirror axis relative to contact element 12 shown in the drawings extending horizontally, i.e. parallel to direction A. In the embodiment shown, FIG. 1 shows a substantially relaxed state of the resilient leg 30. It can be seen from a comparison of FIGS. 1 and 4 that the resilient leg 30 abuts the disconnection portion 22 in a resiliently deflected state, i.e. with a certain biasing force. This can be advantageous in order to use a contact element with the very same shape in further parts of the telecommunications module, in which it is desired to have two contact elements (the one shown in the figures and its mirror image) to be in contact with each other with a certain biasing force, i.e. without a disconnection portion between them. This forms a disconnectable contact, at which, for example, one or more outside contacts of outside modules can be inserted. Thus, in an economically advantageous manner, the same type of contact element can be used throughout the telecommunications module, and the contact elements can be kept disconnected, for example, by the disconnection portion 22 shown in the drawings, or they can be caused to be in contact with a certain biasing force, as desired. However, in the fully inserted state, the resilient leg 30 does not necessarily have to be in a deflected state. Thus, it is possible that the resilient leg 30 has been brought to an end position by the guide, in which it is in a substantially or completely relaxed state. Moreover, it is to be mentioned that the disconnection portion 22 can be replaced by a continued guide in the area, where the disconnection portion 22 is shown. Thus, the continued guide instead of the disconnection portion 22 could be adapted to keep two opposing contact elements permanently disconnected.

In the embodiment shown, the guide 16 is at least partially formed in the “lower half” of the contact receiving space 26, so that this lower half is not easily useable for providing a corresponding guide for the “mirror image” contact element of contact element 12 shown in the drawings. However, not visible in the drawings, the guide for this “mirror image” contact element is formed on that part of the housing which is cutaway to allow the view of FIGS. 1 to 4. Thus, on a portion of the housing, which faces the section shown in the drawings and, thus, borders the receiving space 26, a guide for the “mirror image” contact element is formed essentially as a mirror image of guide 16, with the mirror axis extending substantially horizontally and through disconnection portion 22. Thus, the guide for the “mirror image” contact element extends substantially horizontally in an area adjacent the disconnection portion 22 and forms an upwardly directed ramp in the right part thereof so that substantially a mirror image of guide 16 shown in the drawings is formed. Consequently, the “mirror image” contact element can also be inserted without interfering and/or colliding with the disconnection portion 22 and/or the contact element 12 shown in the drawing.

The present invention has now been described with reference to an embodiment thereof. The foregoing detailed description and embodiment have been given for clarity of understanding only. No unnecessary limitations are to be understood therefrom. For example, all references to horizontal, vertical, upward and downward directions as well as right and left side are exemplary only and do not limit the claimed invention. It will be apparent to those skilled in the art that many changes can be made to the embodiment described without departing from the scope of the invention. Thus, the scope of the present invention should not be limited to the exact details and structures described herein, but rather by the structures described by the language of the claims, and the equivalents of those structures.

1. A telecommunications module having at least one contact element and a housing into which the contact element is inserted, wherein the housing comprises at least one first guide with which at least a portion of the contact element comes in contact during insertion to deflect at least a portion of the contact element.

2. The telecommunications module according to claim 1 wherein the contact element is resiliently deflected by the first guide.

3. The telecommunications module according to claim 1 wherein the housing comprises at least one second guide with which at least a portion of the contact element comes in contact during insertion to apply a force in an opposing direction when the contact element is deflected.

4. The telecommunications module according to claim 1 wherein the contact element has a width extending perpendicular to an insertion direction and the first guide has an extension in the width direction of the contact element which is less than the width of the contact element.

5. The telecommunications module according to claim 1 wherein the first guide comprises a convex portion.

6. The telecommunications module according to claim 2, wherein the contact element is at least partially resiliently deflected in the fully inserted state.

7. The telecommunications module according to claim 1 wherein the housing comprises at least one disconnection portion at which at least two contact elements abut so as to be permanently disconnected.

8. A distribution point in the field of telecommunications comprising at least one telecommunications module in accordance with claim 1.

9. A method of manufacturing a telecommunications module comprising the step of inserting at least one contact element into a housing having at least one first guide, wherein, during the insertion, the contact element is at least partially deflected by the guide.

10. (canceled)
